(19) United States
(12) Patent Application Publication
(10) Pub. No.: US 2024/0146788 A1
(43) Pub. Date: May 2, 2024

(54) Methods, Systems, And Apparatuses For Content Stream Monitoring

(71) Applicant: Comcast Cable Communications, LLC, Philadelphia, PA (US)

(72) Inventor: Toshiro Ozawa, Irvine, CA (US)

(21) Appl. No.: 17/977,595

(22) Filed: Oct. 31, 2022

(51) Int. Cl. H04L 65/611

(52) U.S. Cl. CPC H04L 65/611

(57) ABSTRACT

Methods and systems for monitoring a content stream are described. Streaming health of a playlist file, associated with a master playlist file, received by a client device may be monitored by the client device. The client device may determine health of the content stream by monitoring updates made to the playlist file. The client device may cause a remedial action to be made to the playlist file by indicating that there is an issue with the playlist file to a computing device.

### BACKGROUND

Simultaneously streaming content to a large population of users in different locations around the world may cause an overload to servers tasked to monitor the content streams. More specifically, any number of issues may arise between the distribution of the content stream and its receipt at a client device. Because of this, it has become increasingly difficult to maintain the health of streamed content due to an inability to monitor all content that may be streamed.

### SUMMARY

It is to be understood that both the following general description and the following detailed description are exemplary and explanatory only and are not restrictive. Methods, systems, and apparatuses for content stream monitoring are described herein. A content stream may be associated with a master playlist file that includes information for accessing the content stream (e.g., outputting, viewing, etc.). The master playlist file for the content stream may be monitored and/or updated periodically to ensure that the content stream remains accessible/available. For example, the master playlist file may include information for accessing several versions (e.g., variants) of the content stream, and the information relating to each version may be updated as new information becomes available for each version. The content stream may be monitored by a computing device, such as a client device. For example, the computing device may use the information in the master playlist file to access the content stream. The computing device may monitor the content stream regardless of whether the computing device is outputting content associated with the content stream (e.g., content segments). The computing device may monitor multiple content streams. The computing device may collect data associated with the content stream to determine whether the content stream is accessible/available. The computing device may send the collected data to an upstream device, such as a content server, for example. The computing device or the upstream device may cause a remedial action to occur/be performed, such as when the collected data indicates the content stream (or a version thereof) is no longer accessible/available.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, together with the description, serve to explain the principles of the present methods and systems:

FIG. 1 shows an example system;

FIG. 2 shows an example playlist file;

FIG. 3 shows a flowchart of an example method;

FIG. 4 shows a flowchart of an example method;

FIG. 5A shows example content data;

FIG. 5B shows example content data;

FIG. 6A shows an example content file;

FIG. 6B shows an example content file;

FIG. 7 shows an example system;

FIG. 8 shows a flowchart of an example method;

FIG. 9 shows a flowchart of an example method;

FIG. 10 shows a flowchart of an example method.

FIG. 11 shows a flowchart of an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

Provided herein are methods, systems, and apparatuses for content stream monitoring. Content streams consumed by various over-the-top (OTT) services and devices (e.g., content streaming services, client devices, etc.) may be monitored to ensure accessibility/availability is maintained. Monitoring may be performed by a client-side device(s), (e.g., an end-user device) rather than by an upstream device(s) (e.g., a content server). For example, a client device may monitor a particular content stream(s) of a number of available content streams (e.g., in a service bundle) to determine whether the content stream(s) is ‘live’ or ‘dead’ (e.g., accessible vs. inaccessible, etc.). The client device(s) may not be outputting (e.g., rendering or presenting) the content stream(s) being monitored/checked. The client device(s) may monitor the content stream(s) while outputting a different content stream, while idle, etc.

For example, the client device may be instructed to retrieve (e.g., request) a playlist file, of a plurality of playlist files, associated with a content stream. The client device may monitor the content stream by analyzing data associated with the playlist file and comparing a current version of the playlist file (a “current playlist file”) with a previous version of the playlist file (a “previous playlist file”). The client device may determine that the data associated with the current playlist file is not updating properly, which may be indicative of the content stream being inaccessible or about to become inaccessible. The client device may determine that the data associated with the current playlist file is not updating properly based on a threshold not being met or exceeded. For example, the client device may compare the data associated with the current playlist file and the data associated with the previous playlist file to determine whether the threshold has been met or exceeded. As a further example, the client device may determine that the current playlist file meets or exceeds the threshold based on a comparison between a sequence number of the current playlist file and a sequence number of the previous playlist file. For example, the sequence number of the current playlist file and the sequence number of the previous playlist file may be associated with stream-health (e.g., availability) of the content stream. As another example, the threshold may be met or exceeded if the sequence number associated with the current playlist file is incremented by a configurable value relative to the sequence number associated with the previous playlist file. Additionally, or in the alternative, the client device may determine that the playlist file meets or exceeds the threshold based on a comparison between a start number of the current playlist file and a start number of the previous playlist file. For example, the start number of the current playlist file and the start number of the previous playlist file may be associated with stream-health (e.g., availability) of the content stream. As another example, the threshold may be met or exceeded if the start number associated with the current playlist file is incremented by a configurable value relative to the start number associated with the previous playlist file.

The client device may determine that the playlist file does not meet or exceed the threshold, the client device may cause a remedial action(s) to be performed. For example, the client device may cause the remedial action(s) to be performed based on the threshold not being met or exceeded. The remedial action(s) may comprise, for example, the client device requesting an alternative playlist file, of the plurality of playlist files, to output (e.g., stream) the content stream As another example, the remedial action(s) may comprise, the client device causing the content stream to be repaired, supplemented, and/or replaced. Other examples are possible as well and are described herein.

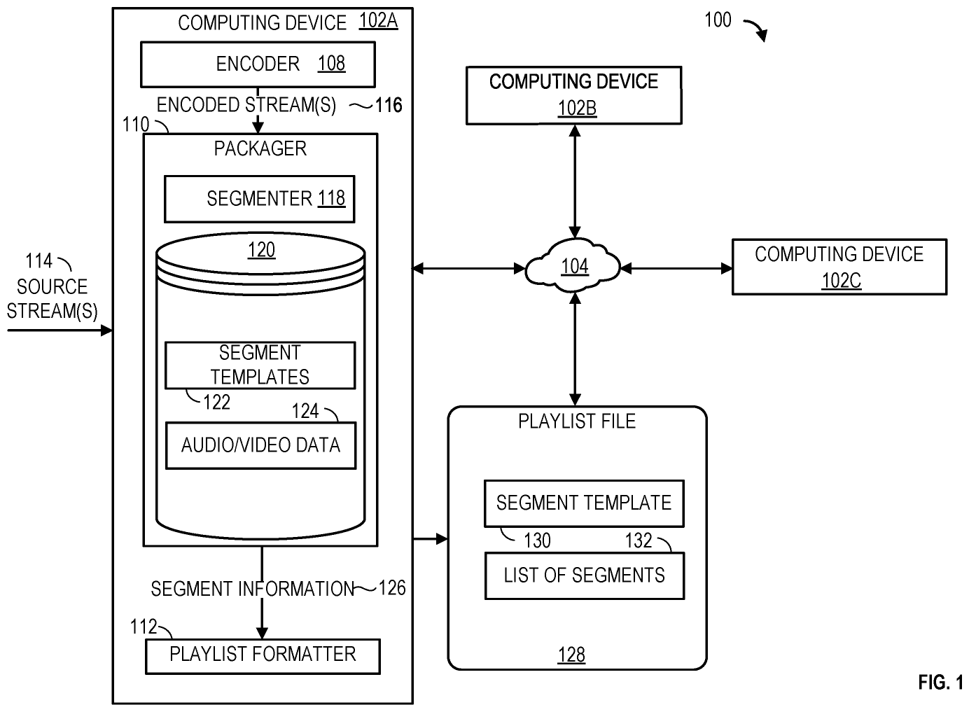

FIG. 1 shows an example system 100 for content stream monitoring. The system 100 may comprise a content delivery network, a data network, a content distribution network, a combination thereof, and/or the like. The system 100 may comprise a computing device 102A in communication with a plurality of other devices via a network 104. The network 104 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent on the network 104 via a variety of transmission paths, including wireless paths (e.g., satellite paths, Wi-Fi paths, cellular paths, etc.) and terrestrial paths (e.g., wired paths, a direct feed source via a direct line, etc.).

The computing device 102A may be an origin device (e.g., a content origin and/or content source) comprising a server, an encoder, a decoder, a packager, a combination thereof, and/or the like. The computing device 102A may generate and/or output portions of content, such as segments or fragments of encoded content (e.g., content streams). For example, the computing device 102A may convert raw versions of content (e.g., broadcast content) into compressed or otherwise more “consumable” versions suitable for playback/output by user devices, media devices, and other consumer-level computing devices. “Consumable” versions of content—or portions thereof—generated and/or output by an origin computing device may include, for example, data files adhering to .MPD, M3U8, H.264/MPEG-AVC, H.265/MPEG-HEVC, H.266/MPEG-VVC, MPEG-5 EVC, MPEG-5 LCEVC, AV1, MPEG2, MPEG, MPEG4 UHD, SDR, HDR, 4k, Adobe® Flash® Video (.FLV), ITU-T H.261, ITU-T H.262 (MPEG-2 video), ITU-T H.263, ITU-T H.264 (MPEG-4 AVC), ITU-T H.265 (MPEG HEVC), ITU-T H.266 (MPEG VVC) or any other content data format, whether such format is presently known or developed in the future. For ease of explanation, when referring to the computing device 102A, the description herein may use the phrase “origin computing device” in the singular form. However, it is to be understood that an origin computing device may comprise a plurality of servers and/or a plurality devices that operate as a system to generate and/or output portions of content, convert raw versions of content (e.g., broadcast content) into compressed or otherwise more “consumable” versions, etc.

The system 100 may comprise a computing device 102B. The computing device 102B may be an origin device (e.g., a content origin and/or content source) comprising a server, an encoder, a decoder, a packager, a combination thereof, and/or the like. The computing device 102B may function similarly to the computing device 102A. For example, the computing device 102B may serve as a backup for the computing device 102A in the event the computing device 102A fails or is otherwise unavailable, and the computing device 102A may serve as a backup for the computing device 102B in the event the computing device 102B fails or is otherwise unavailable. While FIG. 1 shows two origin computing devices—the computing device 102A and the computing device 102B— for explanatory purposes, it is to be understood that the system 100 may comprise a plurality of origin computing devices that function similarly to those shown and described herein.

The system 100 may comprise a computing device 102C. The computing device 102C may comprise a content/media player, a set-top box, a client device, a smart device, a mobile device, a user device, a caching device (e.g., an edge cache, a mid-tier cache, a cloud cache), a combination thereof, and/or the like. The computing device 102A and the computing device 102C may communicate via the network 104. The computing device 102C may receive portions of requested content (e.g., streams, segments, fragments, etc.) from the computing device 102A. The computing device 102C may send requests for portions of content directly to the computing device 102A or via one or more intermediary computing devices (not shown), such as caching devices, routing devices, etc. While FIG. 1 shows a single computing device 102C for explanatory purposes, it is to be understood that the system 100 may comprise a plurality of computing devices that function similarly to the computing device 102C. The computing device 102C may communicate in a similar manner with the computing device 102B, for example.

The computing device 102A may comprise a plurality of modules/components, such as an encoder 108, a packager 110, and/or a playlist formatter 112, each of which may correspond to hardware, software (e.g., instructions executable by one or more processors of the computing device 102A), or a combination thereof. The encoder 108 may perform bitrate conversion, coder/decoder (CODEC) conversion, frame size conversion, etc. For example, the computing device 102A may receive a content source stream 114, and the encoder 108 may encode the content source stream 114 to generate one or more encoded streams 116 (e.g., encoded portions of content, such as segments). The content source stream 114 may be a live stream (e.g., a linear content stream) or a video-on-demand (VOD) stream. The computing device 102A may receive the content source stream 114 from an external source (e.g., a stream capture source, a data storage device, a media server, etc.). The computing device 102A may receive the content source stream 114 via a wired or wireless network connection, such as the network 104 or another network (not shown). Although a single content source stream 114 is shown in FIG. 1, the computing device 102A may receive any number of content source streams 114 for any number of content items.

The encoder 108 may generate a plurality of encoded streams 116. Each encoded stream of the plurality of encoded streams 116 may correspond to a particular adaptive bitrate (ABR) representation of a content item received via the content source stream 114. For example, the plurality of encoded streams 116 may differ from one other with respect to an audio bitrate(s), a number of audio channels, an audio CODEC(s), a video bitrate(s), a video frame size(s), a video CODEC(s), a combination thereof, and/or the like. The encoder 108 may encode the content source stream 114 such that key frames (e.g., intra-coded frames (I-frames)) in the plurality of encoded streams 116 occur corresponding to times relative to those of the content source stream 114. That is, each of the plurality of encoded streams 116 may be “key frame aligned” to enable seamless switching between different ABR representations by a destination device (e.g., the computing device 102C).

The packager 110 may comprise a segmenter 118 and a data storage device 120. The data storage device 120 may be a component of the packager 110, as shown in FIG. 1, or it may be a separate device/entity within the system 100 (e.g., a cache device, data storage repository, database, etc.) in communication with the packager 110. The segmenter 118 may divide a set of ABR representations of content items (e.g., the plurality of encoded streams 116) into media segments/fragments. For example, the segmenter 118 may receive a target segment duration, such as a quantity of milliseconds, seconds, minutes, etc. The target segment duration may be received via user input (e.g., at the computing device 102C or a user profile); it may be determined via a configuration file at the computing device 102A and/or the computing device 102C; it may be determined based on properties of the content source stream 114; it may be received via the computing device 102A; it may be a combination thereof, and/or the like. For example, if the target segment duration is ten seconds, the segmenter 118 may segment (e.g., separate, divide, etc.) the plurality of encoded streams 116 into segments (e.g., at key frame boundaries). The segments may comprise a set duration, such as 5-6 seconds, depending on a format of the segments.

The computing device 102A may support multiple content segmentation types (e.g., formats). The segmenter 118 may generate segments for each of the content segmentation types supported by the computing device 102A. Segments may be referred to as “chunks” herein. The computing device 102A may support both multiplexed segments (video and audio data included in a single multiplexed stream) and non-multiplexed segments (video and audio data included in separate non-multiplexed streams). For example, in the case of segments adhering to the MPEG-DASH or HLS standards, the computing device 102A may support container formats in compliance with an international standards organization base media file format (e.g., ISOBMFF, associated with a file extension “.m4s”), Moving Picture Experts Group 2 transport stream (e.g., MPEG-TS), extensible binary markup language (e.g., EBML), WebM, Matroska, or any combination thereof.

The segmenter 118 may employ a “smart” storage system to avoid replicating audio/video data during generation of segments for each content segmentation type. For example, if the computing device 102A supports N content segmentation types (where N is an integer greater than zero), the segmenter 118 may generate N segment templates 122 for each segment (e.g., portion) of each of the plurality of encoded streams 116. Each segment template 122 may comprise or refer to timing data for the segment based on a given format of the segment. In the example of MPEG-DASH and/or HLS segments, different segment templates may be generated for ISOBMFF multiplexed (“muxed”), ISOBMFF non-multiplexed (“demuxed”), MPEG-TS muxed, MPEG-TS demuxed, EBML muxed, EBML demuxed, etc.

The timing data may comprise or indicate a start position/start time of a particular segment and an end position/end time of the particular segment in the content source stream 114. For example, the timing data for a particular segment may comprise presentation timestamp (PTS) values that relate a time that the particular segment was encoded and/or transcoded (e.g., by the encoder 108) to a beginning of the particular content item. The PTS values for a particular segment may ensure that underlying audio/video data 124 (e.g., audio and video frames) for the segment is synchronized.

The content source stream 114 may comprise textual information for each content item. The textual information may comprise closed captioning/subtitle content. The textual information may be encoded into the plurality of encoded streams 116 by the encoder 108. For example, captions data corresponding to the textual information may be encoded into each of the plurality of encoded streams 116.

Each of the segment templates 122 may not include the underlying audio/video data 124 (e.g., audio and video frames) of the corresponding segment. For example, while multiple segment templates 122 may be generated for each segment of the content source stream 114, the underlying audio/video data 124 for each segment may be stored once for each ABR representation. As the segment templates 122 are generated, the segmenter 118 may generate and/or send segment information 126 regarding the segment templates 122 to the playlist formatter 112. The segment information 126 for a particular segment may comprise the corresponding segment template 122 and refer to (e.g., be indicative of a storage location of) the underlying audio/video data 124 (e.g., audio and video frames).

The playlist formatter 112 may generate playlist files based on the segment information 126 received from the packager 110, including information associated with the segment(s) of the adaptive streaming representation(s) generated by the encoder 108. The playlist files may comprise manifest files, such as MPEG-DASH media presentation description (MPD) files for MPEG-DASH and/or master and variant playlist files (.m3u8) for HLS content.

The term “playlist” as used herein (e.g., a “playlist,” a “variant playlist,” a “master playlist,” a “playlist file,” etc.) may comprise a manifest, such as a manifest file, a variant manifest file, a top-level manifest file, and/or any other suitable file or data structure that facilitates access to content items (e.g., segments of content). Any “playlist” or “manifest” described herein is intended to be protocol-agnostic. For example, any “playlist” or “manifest” described herein may be compatible with any chunk-based, fragment-based, and/or segment-based streaming protocol known or developed.

The playlist formatter 112 may generate one or more playlist files (e.g., manifests). The playlist formatter 112 may generate one or more playlist files based on a manifest type and/or a content segmentation type. If the manifest type is number-based or time-based, the playlist formatter 112 may generate, based on the segment information 126, a playlist file 128 that comprises a segment template 130. The segment template 130 may be number-based or time-based. A number-based segment template 130 may be used (e.g., by the computing device 102C) to construct segment identifiers (e.g., filename(s), URL(s), address(es), etc.) to request individual segments according to a corresponding segment number. A time-based segment template 130 may be used (e.g., by the computing device 102C) to construct segment identifiers to request individual segments according to a corresponding segment start time. If the segment template 130 is list-based, the playlist formatter 112 may generate, based on the segment information 126, the playlist file 128 that comprises a list of segment identifiers 132. The list of segment identifiers 132 may include segment identifiers that are specific to one or more segments of one or more ABR representations (e.g., one or more variant playlist files).

The playlist formatter 112 may generate a separate playlist file for each of a plurality of variant files of the particular content item (e.g., adaptive streaming representations). As further described herein, the playlist formatter 112 may generate a master playlist file that references each of the separate playlist files for each of the plurality of variant files. For example, the encoded streams 116 generated by the encoder 108 may include three variant files (e.g., adaptive streaming representations) of the content source stream 114: a first variant file with a bit rate of 2 megabits per second (Mbps) and a resolution of 720p, a second variant file with a bit rate of 750 kilobits per second (Kbps) and a resolution of 160p, and a third variant file with a bit rate of 250 kbps and a resolution of 120p. More, fewer, and/or different variant files (e.g., adaptive streaming representations) may be generated by the encoder 108. The playlist file 128 may comprise the master playlist file or a variant playlist file, unless otherwise specified herein. The playlist file 128 may identify a list of segment identifiers 132 of a particular content item. The playlist file 128 may identify a list of segment identifiers 132 of the particular content item based on the audio/video data 124 (e.g., audio and video frames).

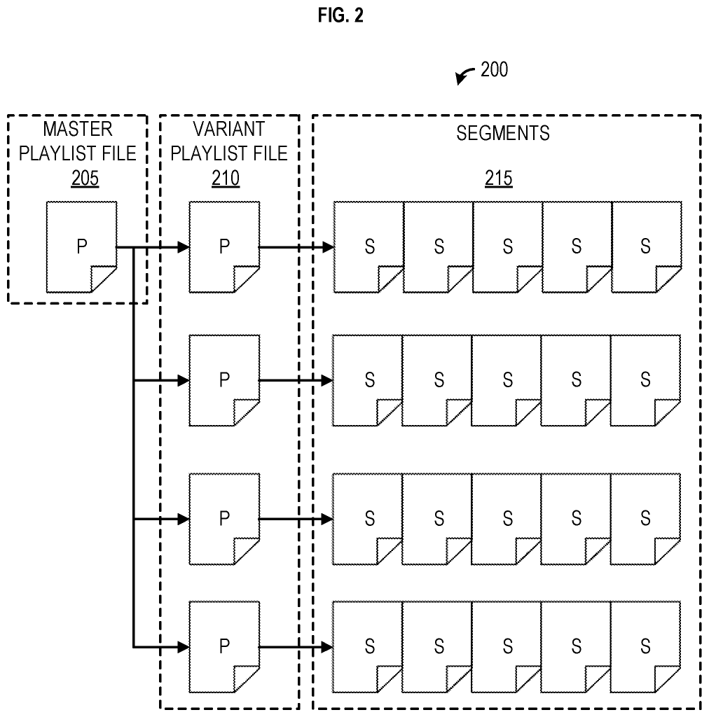

FIG. 2 shows an example structure of playlist files 200 for a content item that the playlist formatter 112 may generate. The structure of the playlist files 200 depicted in FIG. 2 may be an example of an HLS-specific structure, for example. As another example, the playlist formatter 112 may generate a master playlist file 205 for the content item (e.g., a master playlist version of the playlist file 128). The master playlist file 205 may reference a plurality of variant playlist files 210. Each of the plurality of variant playlist files 210 may correspond to one of the encoded streams 116 generated by the encoder 108 (e.g., an adaptive streaming representation). Each of the plurality of variant playlist files 210 may identify or comprise a plurality of segments 215 (e.g., content segments) of the content item (e.g., generated by the segmenter 118).

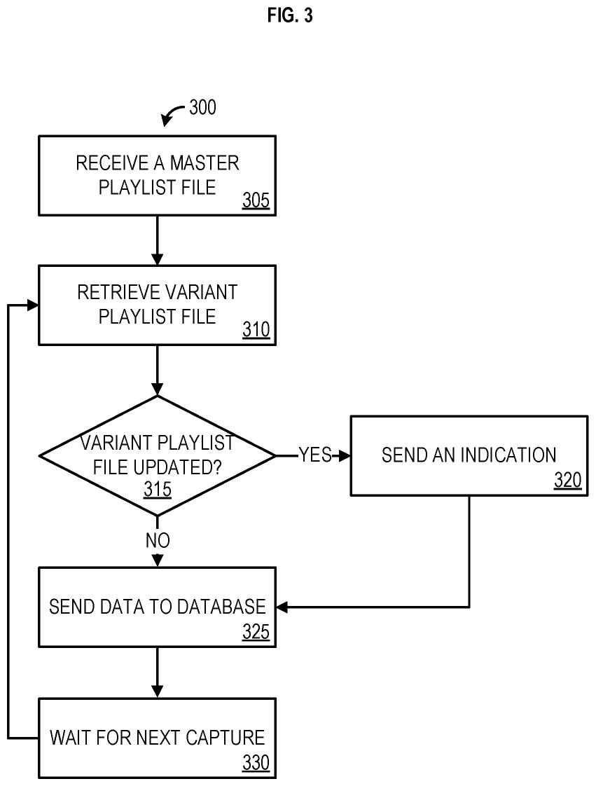

FIG. 3 shows a flowchart of an example method 300 for content stream monitoring. The method 300 may be performed in whole or in part by the computing device 102C (or by any other device(s) of the system 100). The computing device 102C may not be outputting (e.g., rendering or presenting) the content stream(s) being monitored/checked. The computing device 102C may monitor the content stream(s) while outputting a different content stream, while idle, etc.

At step 305, the master playlist file 205 may be received. For example, the computing device 102C may send a request for the master playlist file 205 to the computing device 102A, 102B. In response to the request from the computing device 102C, the computing device 102A, 102B may send the master playlist file 205 to the computing device 102C. The master playlist file 205 may serve as an index to the plurality of variant playlist files 210 (e.g., the plurality of variant playlist files 210). Each playlist file of the plurality of variant playlist files 210 may be representative of the same content at varying bitrates (e.g., various representations). At step 310, the playlist file of the plurality of variant playlist files 210 may be retrieved. The playlist file of the plurality of variant playlist files 210 may be associated with the master playlist file 205 received at step 305. For example, the playlist file may comprise a variant playlist file (e.g., variant playlist file 210) associated with the master playlist file (e.g., master playlist file 205). For example, the computing device 102C may retrieve, based on a performance capability of the computing device 102C, a particular playlist file of the plurality of variant playlist files 210 representative of a requested content at an appropriate quality level (e.g., bitrate). For example, an appropriate quality level indicates that the bitrate of the requested content may be of a format that would conform to the performance capability of the computing device 102C. Each of the plurality of variant playlist files 210 may be comprised of one or more content segments (e.g., segments 215). The computing device 102C may determine a download speed or a caption availability associated with the content. For example, the computing device 102C may determine a download speed or a caption availability associated with the content based on the one or more content segments. The computing device 102C may monitor the download speed and/or the caption availability associated with the streaming content to determine whether the content stream(s) is ‘live’ or ‘dead’ (e.g., accessible vs. inaccessible, etc.).

In an aspect, step 310 may be omitted. Because an MPEG-DASH formatted playlist file may only require a single .mpd file, the retrieval of a variant playlist file (described in step 310) may not be necessary for the method 300 to successfully monitor the content stream. For example, the playlist file of the plurality of variant playlist files 210 may be in a MPEG-DASH format, and may be received at step 305. As a further example, the playlist file of the plurality of variant playlist files 210 may be received by the computing device 102C. As another example, the MPEG-DASH formatted playlist file of the plurality of variant playlist files 210 may be received at step 305, wherein the master playlist file 205 may be a singular .mpd file that may be periodically updated. By contrast, the method 300 may operate to monitor HLS-specific content streams for example. HLS-specific content streams, as is described herein, may require the retrieval of a variant playlist (described in step 310).

At step 315, the computing device 102C may determine whether the playlist file of the plurality of variant playlist files 210 has been updated. For example, the computing device 102C may determine whether the playlist file of the plurality of variant playlist files 210 has been updated based on data associated with the content stream of the retrieved playlist file of the plurality of variant playlist files 210. For example, the data may be indicative of a value. For example the data may be indicative of a value, wherein the value may represent one or more performance metrics. For example, the one or more performance metrics may comprise one or more of a sequence number, an asset change, a cue message, or a number of content segments. For example, a sequence number may be assigned to each content segment and may indicate an error in the content stream in the case wherein the sequence number is not updated. As an additional example, the asset change may be a change in the master playlist file 205, indicative of a new content stream that may be played. As a further example, the cue message may be a notification indicative of an error in the content stream. Additionally, the number of content segments may be consistent, so that in the instance wherein the content segment may be consumed, a new content segment is added to the queue of content segments so that content may continue to be streamed to a client device. Furthermore, the one or more performance metrics may be any metric associated with data associated with the content stream, for example.

As another example, the computing device 102C may determine that the playlist file of the plurality of variant playlist files 210 has been updated based on a comparison between a sequence number of a current variant playlist file of the plurality of variant playlist files 210 and a sequence number of a previous variant of the same playlist file of the plurality of variant playlist files 210, as will be further discussed. For example, the computing device 102C may determine that the playlist file of the plurality of variant playlist files 210 has been updated based on a number of content segments changing so that the consumption of one or more content segments (e.g., segments 215) are indicated, as will be further discussed. More specifically, the content segments may be identified by the sequential segment number, for example. As a further example, the computing device 102C may determine that the playlist file of the plurality of variant playlist files 210 has been updated based on a notification that may be received by the computing device 102C that may indicate any type of change to the content item associated with the plurality of variant playlist files 210. Additionally, for example, the computing device 102C may monitor the plurality of variant playlist files 102C. As a further example, the computing device 102C may monitor the plurality of variant playlist files 210 to determine whether the content stream(s) is ‘live’ or ‘dead’ (e.g., accessible vs. inaccessible, etc.). The computing device 102C may also determine real-time updates regarding a quality of the content stream via a cue message that may indicate an issue with the quality of the content stream.

As an example, the computing device 102C may receive an instruction to monitor the one or more performance metrics at step 315. For example the instructions may be based on a geographic location of the computing device 102C, a device platform, or a device capability. For example, the device capability may be associated with one or more of a rate plan, a connection speed, or a hardware performance.

The entirety of the steps (e.g., 305-330) of the flowchart depicted in FIG. 3 may be individually implemented, per playlist file of the plurality of variant playlist files 210, so that each of the plurality of variant playlists 210 may be simultaneously monitored by a single device (e.g., computing device 102C) as content is streamed to the computing device 102C. For example, the additionally monitored content streams may be unrelated to the actively streamed content. As a further example, a plurality of client devices (e.g., computing device 102C) may collaboratively communicate with the computing device 102A, 102B (e.g., a server) so that a maximum amount of content streams may be monitored by the computing device 102A, 102B. As an example, each client device from a plurality of client devices may monitor a total of ten content streams. Each of the client devices may report respectively collected data. For example, each of the client devices may report respectively collected data, determined based on monitoring the received content stream, to the computing device 102A, 102B, so that if 100 client devices communicate a monitoring report to the computing device 102A, 102b, 1000 content streams may effectively be monitored simultaneously.

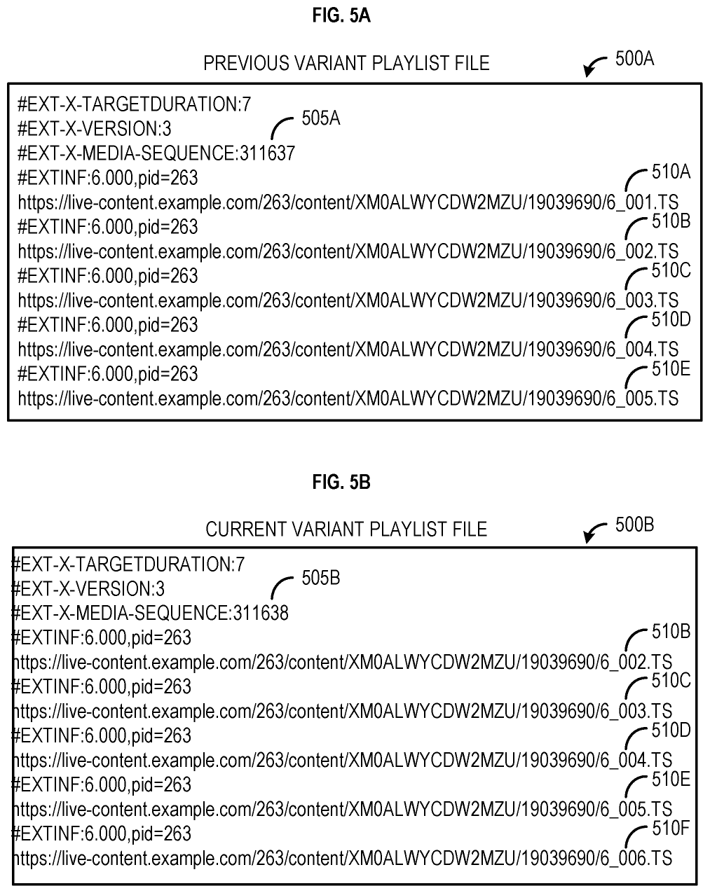

For example, FIGS. 5A-5B show that the playlist file of the plurality of variant playlist files 210 may represent that an update to a playlist file of the plurality of variant playlist files 210 has occurred relative to a previous variant playlist file 500A associated with the content stream. More specifically, FIG. 5A shows a first version of the playlist file 500A and FIG. 5B shows a second version of the playlist file 500B. The computing device 102C may determine that the playlist file of the plurality of variant playlist files 210 has been updated based on a sequence number. For example, the sequence number (e.g., “311637 or 311638”) may be incremented between a current variant playlist file 500B and the previous variant playlist file 500A by a configurable value (e.g., a predetermined threshold). For example, the configurable value may be one (e.g., “1”), and a successful update of the playlist file may represent a sequence number 505A (e.g., “311637”) increasing by one (e.g., “1”), to result in a sequence number 505B (e.g., “311628”). The computing device 102C may determine that the playlist file of the plurality of variant playlist files 210 has been updated based on the consumption of a queue of content segments (e.g., content segments 510A-510F). For example, the computing device 102C may determine that a successful update of the playlist file of the plurality of variant playlist files 210 may indicate that a first content segment 510A of the previous variant playlist file 500A has been consumed and a sixth content segment 510F has been added to the queue of content segments prepared to be streamed, as is shown in the current variant playlist file 500B. The computing device 102C may determine that the content video is ‘dead’ (e.g., inaccessible, non-functional, etc.). For example, the computing device 102C may determine that the content video is ‘dead’ based on the sequence number remaining the same, and not updating.

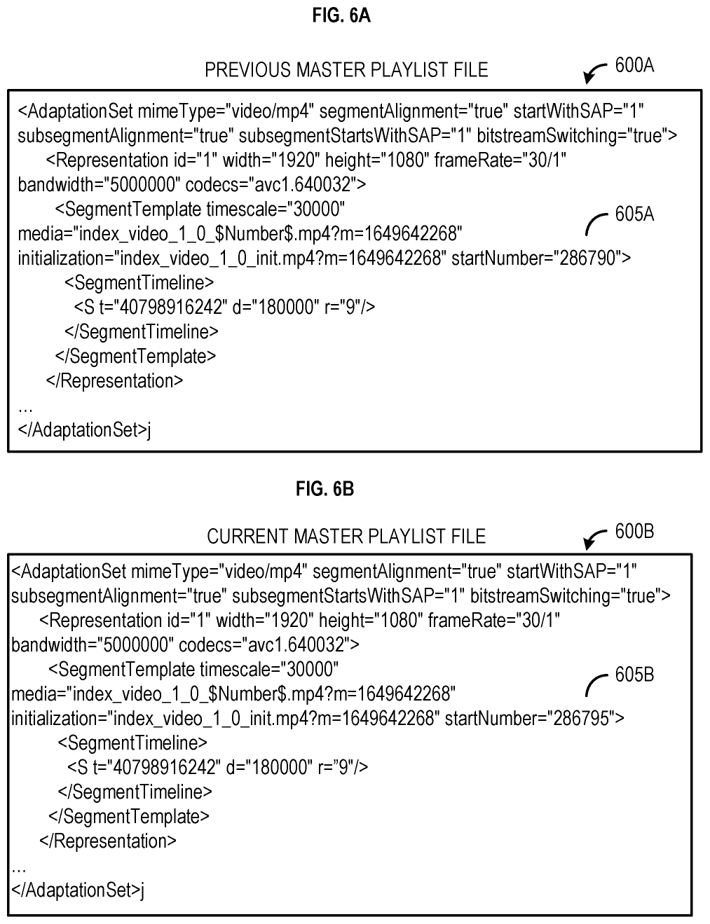

FIGS. 6A-6B show example content data associated with the master playlist file 205. More specifically, FIG. 6A shows a first version of the content data and FIG. 6B shows a second version of the content data. The content data depicted in FIGS. 6A-6B may be example instances of an MPEG-DASH-specific file. As another example, the playlist formatter 112 may generate the master playlist file 205 of the MPEG-DASH file for the content item. In one example, stream-health (e.g., availability) may be monitored by an analysis of a start number. For example, a healthy content stream may reflect an increase of the start number (e.g., “286790”) of a previous master playlist (e.g., previous master playlist 600A) to the start number (e.g., “286795”) of a current version of the same master playlist (e.g., current master playlist 600B) equivalent to a configurable value (e.g., a predetermined threshold). For example, the configurable value may be five (e.g., “5”), and a successful update of the master playlist file may represent a start number 605A (e.g., “286790”) increasing by five (e.g., “5”), to result in a start number 605B (e.g., “286795”). In the instance wherein a change is not reflected in the start number, the content stream may be considered to be ‘dead’ (e.g., inaccessible, non-functional, etc.).

Returning to step 315 of FIG. 3, the computing device 102C may determine that the playlist file of the plurality of variant playlist files 210 has not been updated. The computing device 102C may determine that the playlist file of the plurality of variant playlist files 210 has not been updated at step 315, the computing device 102C may send an indication (at step 320) to the computing device 102A, 102B. However, the computing device 102C may send an indication to any other computing device via the network 104 at step 320, for example. The indication sent at step 320 may be an alert indicative of an error in the streaming of the playlist file of the plurality of variant playlist files 210. For example, the error may be identified by a change in a sequence number, an asset change, a cue message indicating a change, or a change in the number of segments. For example, a sequence number may be assigned to each content segment and may indicate an error in the content stream in the case wherein the sequence number is not updated. As an additional example, the asset change may be a change in the master playlist file 205, indicative of a new content stream that may be played. As a further example, the cue message may be a notification indicative of an error in the content stream. Additionally, the number of content segments may be consistent, so that in the instance wherein the content segment may be consumed, a new content segment is added to the queue of content segments so that content may continue to be streamed to a client device. In each instance wherein the computing device 102C determines that the playlist file of the plurality of variant playlist files 210 has updated or has not updated, the computing device 102C may upload the data associated with the playlist file of the plurality of variant playlist files 210 to a database at step 325. The database may be located remotely relative to the computing device 102C, for example. As another example, the database may be located internally within the computing device 102C as well. At step 330, the computing device 102C may wait for a predetermined amount of time before retrieving a second playlist file of the plurality of variant playlist files 210. The second playlist file of the plurality of variant playlist files 210 may be an updated version of the preceding playlist file of the plurality of variant playlist files 210 that was initially retrieved, for example. As another example, the second playlist file of the plurality of variant playlist files 210 may also be a new variant playlist file of the plurality of variant playlist files 210.

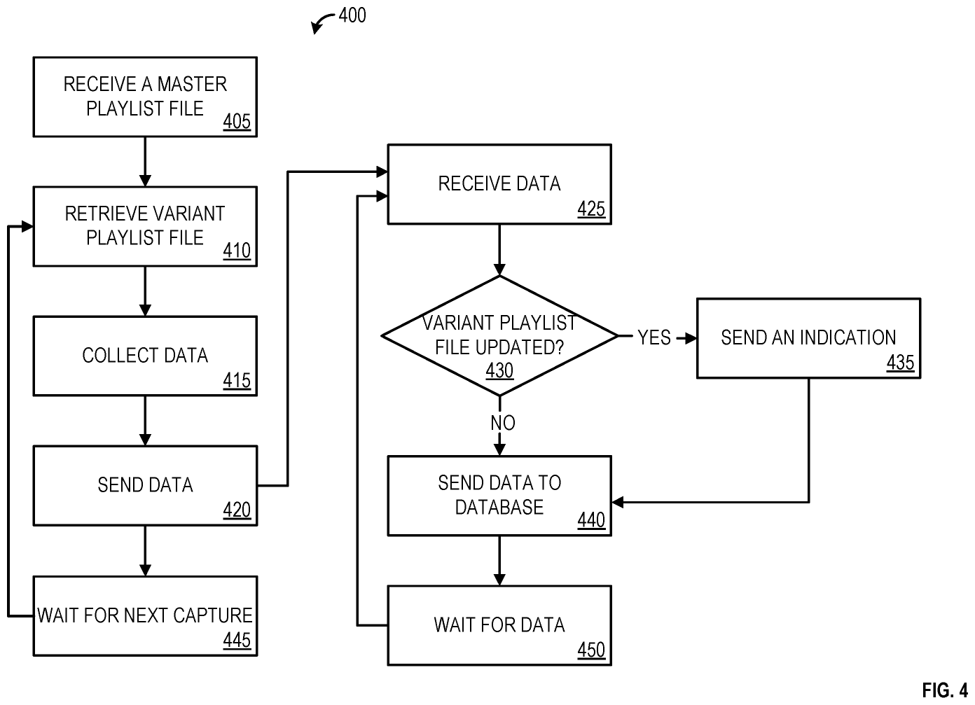

FIG. 4 shows a flowchart of an example method 400 for content stream monitoring. The example method 400 is a rendition of the example method of 300 that may allow for the computing device 102C to collect data (e.g., step 415) and send the data to the computing device 102A, 102B, so that the computing device 102A, 102B may monitor the stream-health (e.g., availability) of the playlist file of the plurality of variant playlist files 210. By contrast, the example method 300 may complete the entirety of the example method 400 (e.g., steps 405-450) within the computing device 102C. The method 400 may be performed through the communication between the computing device 102C and the computing device 102A, 102B via the network 104. At step 405, the master playlist file 205 may be received. For example, the computing device 102C may send a request for the master playlist file 205 to the computing device 102A, 102B. The master playlist file 205 may serve as an index to the plurality of variant playlist files 210. For example, the master playlist file 205 may serve as an index to the plurality of variant playlist files 210, wherein each playlist file of the plurality of variant playlist files 210 may be representative of the same content at varying bitrates. At step 410, a playlist file of the plurality of variant playlist files 210 may be retrieved. The playlist file of the plurality of variant playlist files 210 may be associated with the master playlist file 205 received at step 405. For example, the playlist file may comprise a variant playlist file (e.g., variant playlist file 210) associated with the master playlist file (e.g., master playlist 205). For example, the computing device 102C may retrieve a particular playlist file of the plurality of variant playlist files 210 representative of a requested content at an appropriate quality level (e.g., bitrate). As a further example, the computing device 102C may retrieve, based on the performance capability of the computing device 106, the particular playlist file of the plurality of variant playlist files 210 representative of the requested content at the appropriate quality level (e.g., bitrate). For example, an appropriate quality level indicates that the bitrate of the requested content may be of a format that would conform to the performance capability of the computing device 102C. Each of the plurality of variant playlist files 210 may be comprised of one or more content segments (e.g., segments 215). The computing device 102C may determine a download speed or a caption availability associated with the content. For example, the computing device 102C may determine the download speed or the caption availability associated with the content based on the one or more content segments. The computing device 102C may monitor the download speed and/or the caption availability associated with the streaming content to determine whether the content stream(s) is ‘live’ or ‘dead’ (e.g., accessible vs. inaccessible, etc.).

At step 415, the computing device 102C may collect data associated with a content stream of the retrieved playlist file of the plurality of variant playlist files 210. For example, the data may be indicative of a value. The value may represent one or more performance metrics. For example, the one or more performance metrics may comprise one or more of a sequence number, an asset change, a cue message, or a number of content segments. For example, a sequence number may be assigned to each content segment and may indicate an error in the content stream in the case wherein the sequence number is not updated. As an additional example, the asset change may be a change in the master playlist file 205, indicative of a new content stream that may be played. As a further example, the cue message may be a notification indicative of an error in the content stream. Additionally, the number of content segments may be consistent, so that in the instance wherein the content segment may be consumed, a new content segment is added to the queue of content segments so that content may continue to be streamed to a client device. The one or more performance metrics may be any metric associated with data associated with a content stream, for example. The computing device 102C may upload the data collected in step 415 to the computing device 102A, 102B at step 420. As another example, the computing device 102C may upload the data collected in step 415 to any computing device via the network 104.

In an aspect, step 410 may be omitted. Because a MPEG-DASH formatted playlist file may only requires a single .mpd file, the retrieval of a variant playlist file (described in step 410) may not be necessary for the method 400 to successfully monitor the content stream. For example, the playlist file of the plurality of variant playlist files 210 may be in a MPEG-DASH formatted playlist file of the plurality of variant playlist files 210 may be received at step 405. As another example, the MPEG-DASH formatted playlist file of the plurality of variant playlist files 210 may be received at step 405, wherein the master playlist file 205 may be a singular .mpd file that may be periodically updated. By contrast, the method 400 may operate to monitor HLS-specific content streams for example. HLS-specific content streams, as is described herein, may require the retrieval of a variant playlist file (described in step 410).

At step 425, the computing device 102A, 102B may receive the data collected in step 415. At step 430, the computing device 102A, 102B may determine whether the playlist file of the plurality of variant playlist files 210 has been updated. For example at step 430, the computing device 102A, 102B may determine whether the playlist file of the plurality of variant playlist files 210 has been updated based on the data received in step 425. As another example, the computing device 102A, 102B may determine that the playlist file of the plurality of variant playlist files 210 has been updated based on a comparison between the sequence number (e.g., sequence number 505A, 505B) of the current variant playlist file (e.g., current variant playlist file 500A) and the sequence number of the previous variant of the same playlist file (e.g., previous variant playlist file 500B), as will be further discussed. For example, the computing device 102A, 102B may determine that the playlist file of the plurality of variant playlist files 210 has been updated based on a number of content segments changing so that the consumption of one or more content segments (e.g., segments 215) are indicated, as will be further discussed. For example, FIGS. 5A-5B show how the playlist file of the plurality of variant playlist files 210 may represent that an update to the playlist file of the plurality of variant playlist files 210 has occurred relative to the previous variant playlist 500A associated with the content stream. The computing device 102C may determine that the playlist file of the plurality of variant playlist files 210 has been updated based on the sequence number. For example, the sequence number (e.g., “311637 or 311638”) may be incremented between the current variant playlist file 500B and the previous variant playlist file 500A by a configurable value (e.g., a predetermined threshold). For example, the configurable value may be one (e.g., “1”), and a successful update of the playlist file may represent the sequence number 505A (e.g., “311637) increasing by one (e.g., “1”), to result in the sequence number 505B (e.g., “311628”). The computing device 102C may determine that the playlist has been updated based on the consumption of the queue of content segments (e.g., content segments 510A-510F). For example, the computing device 102C may determine that a successful update of the playlist file may indicate that the first content segment 510A of the previous variant playlist 500A has been consumed and the sixth content segment 510F has been added to the queue of content segments prepared to be streamed, as is shown in the current variant playlist 500B. In the instance wherein a change may not be not reflected in the sequence number, the content stream may be considered to be ‘dead’ (e.g., inaccessible, non-functional, etc.).

As an example, the computing device 102C may receive an instruction to monitor the one or more performance metrics at step 430. For example the instructions may be based on a geographic location of the computing device 102C, a device platform, or a device capability. For example, the device capability may be associated with one or more of a rate plan, a connection speed, or a hardware performance.

As another example, FIGS. 6A-6B show how the playlist file may represent that an update to the current master playlist file 600B has occurred relative to the previous version 600A of the same master playlist file. The computing device 102C may determine that the playlist file of the plurality of variant playlist files 210 has been updated based on the start number. For example, the start number (e.g., “286790” or “286795”) may be incremented between the current master playlist file 600B and the previous master playlist file 600A by a configurable value (e.g., a predetermined threshold). For example, the configurable value may be five (e.g., “5”), and a successful update of the playlist file may represent a start number 605A (e.g., “286790”) increasing by five (e.g., “5”), to result in a start number 605B (e.g., “286795”).

Returning to FIG. 4, the computing device 102A, 102B may determine that the playlist file of the plurality of variant playlist files 210 has not been updated (e.g., at step 430). The computing device 102A, 102B may send an indication to a computing device (not shown) via the network 104. In each instance wherein The computing device 102A, 102B may upload the data associated with the playlist file of the plurality of variant playlist files 210 to the database at step 440. For example, the computing device 120A, 120B may upload the data associated with the playlist file of the plurality of variant playlist files 210 to the database based on a determination that the playlist file of the plurality of variant playlist files 210 has updated or has not updated. The database may be located remotely relative to the computing device 102A, 102B, for example. As another example, the database may be located internally within the computing device 102A, 102B as well. At step 445, the computing device 102C may wait for a predetermined amount of time before retrieving a second playlist file of the plurality of variant playlist files 210. The second playlist file of the plurality of variant playlist files 210 may be an updated version of the preceding playlist file of the plurality of variant playlist files 210 that was retrieved, for example. As another example, the second playlist file of the plurality of variant playlist files 210 may also be a new variant playlist of the plurality of variant playlists 210. At step 450, the computing device 102A, 102B may wait for a predetermined amount of time before receiving more data as is described in step 420.

Each of the steps 405-445 of the flowchart depicted in FIG. 4 may be individually implemented, per playlist file of the plurality of variant playlist files 210, so that each of the plurality of variant playlists 210 may be simultaneously monitored by a single device (e.g., computing device 120C) as content is streamed to the computing device 102C. For example, the additionally monitored content streams may be unrelated to the actively streamed content. As a further example, a plurality of client devices (e.g., computing device 120C) may collaboratively communicate with the computing device 102A, 102B (e.g., a server) so that a maximum amount of content streams may be monitored by the computing device 102A, 102B. As an additional example, each client device from a plurality of client devices may monitor a total of ten content streams. Each of the client devices may report respectively collected data. For example, each of the client devices may report respectively collected data, determined based on monitoring the content stream to a computing device, so that if 100 client devices communicate a monitoring report to the computing device, 1000 content streams may effectively be monitored simultaneously.

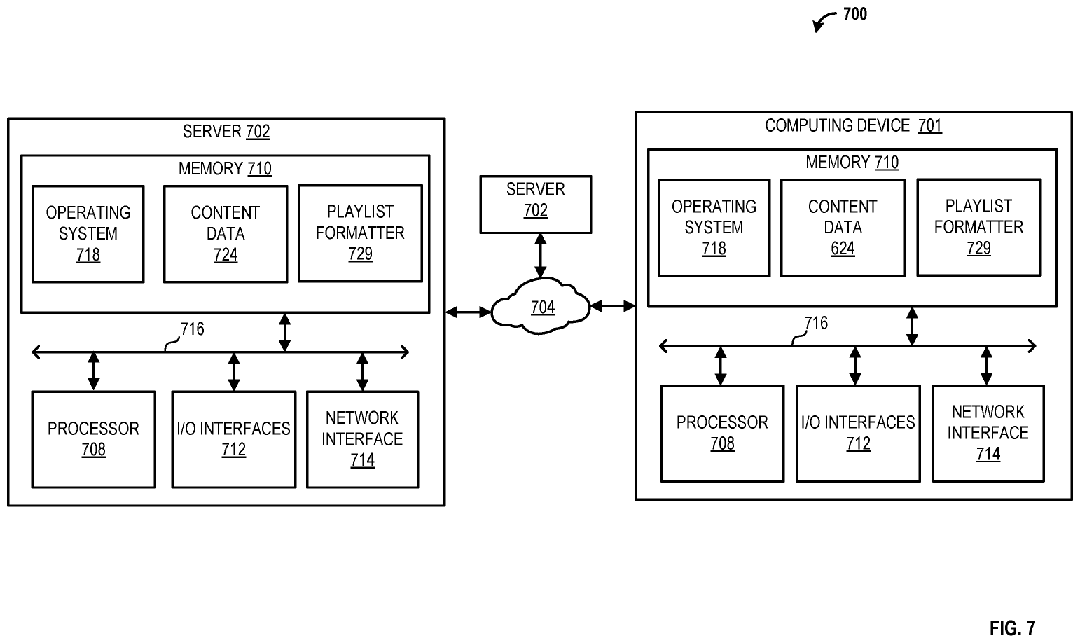

The present methods and systems may be computer-implemented. FIG. 7 shows a block diagram depicting a system/environment 700 comprising examples of a computing device 701 and a server 702 connected through a network 704. Either of the computing device 701 or the server 702 may be a computing device, such as any of the computing devices 102A, 102B or the computing device 102C of the system 100 shown in FIG. 1. In an aspect, some or all the steps of any described method may be performed on a computing device as described herein. The computing device 701 may comprise one or multiple computing devices configured to store one or more of a playlist formatter 729, and/or the like. The server 702 may comprise one or multiple computing devices configured to store content data 724 (e.g., a plurality of content segments). Multiple servers 702 may communicate with the computing device 701 via the network 704.

The computing device 701 and the server 702 may be a digital computer that, in terms of hardware architecture, generally includes a processor 708, system memory 710, input/output (I/O) interfaces 712, and network interfaces 714. These components (708, 710, 712, and 714) are communicatively coupled via a local interface 716. The local interface 716 may be, for example, but not limited to, one or more buses or other wired or wireless connections, as is known in the art. The local interface 716 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 708 may be a hardware device for executing software, particularly stored in the system memory 710. The processor 708 may be any custom made or commercially available processor, a central processing unit (CPU), an auxiliary processor among several processors associated with the computing device 701 and the server 702, a semiconductor-based microprocessor (in the form of a microchip or chip set), or generally any device for executing software instructions. During operation of the computing device 701 and/or the server 702, the processor 708 may execute software stored within the system memory 610, to communicate data to and from the system memory 710, and to generally control operations of the computing device 701 and the server 702 pursuant to the software.

The I/O interfaces 712 may be used to receive user input from, and/or for sending system output to, one or more devices or components. User input may be received via, for example, a keyboard and/or a mouse. System output may be output via a display device and a printer (not shown). The I/O interfaces 712 may include, for example, a serial port, a parallel port, a Small Computer System Interface (SCSI), an infrared (IR) interface, a radio frequency (RF) interface, and/or a universal serial bus (USB) interface.

The network interface 714 may be used to transmit and receive from the computing device 701 and/or the server 702 on the network 704. The network interface 714 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 714 may include address, control, and/or data connections to enable appropriate communications on the network 704.

The system memory 710 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 710 may incorporate electronic, magnetic, optical, and/or other types of storage media. Note that the system memory 710 may have a distributed architecture, where various components are situated remote from one another, but may be accessed by the processor 708.

The software in system memory 710 may include one or more software programs, each of which comprises an ordered listing of executable instructions for implementing logical functions. In the example of FIG. 7, the software in the system memory 710 of the computing device 701 may comprise the playlist formatter 729, the content data 724, and a suitable operating system (O/S) 718. In the example of FIG. 7, the software in the system memory 710 of the server 702 may comprise the playlist formatter 729, the content data 724, and a suitable operating system (O/S) 718. The operating system 718 essentially controls the execution of other computer programs and enables scheduling, input-output control, file and data management, memory management, and communication control and related services.

For purposes of illustration, application programs and other executable program components such as the operating system 718 are shown herein as discrete blocks, although it is recognized that such programs and components may reside at various times in different storage components of the computing device 701 and/or the server 702. An implementation of the system/environment 700 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

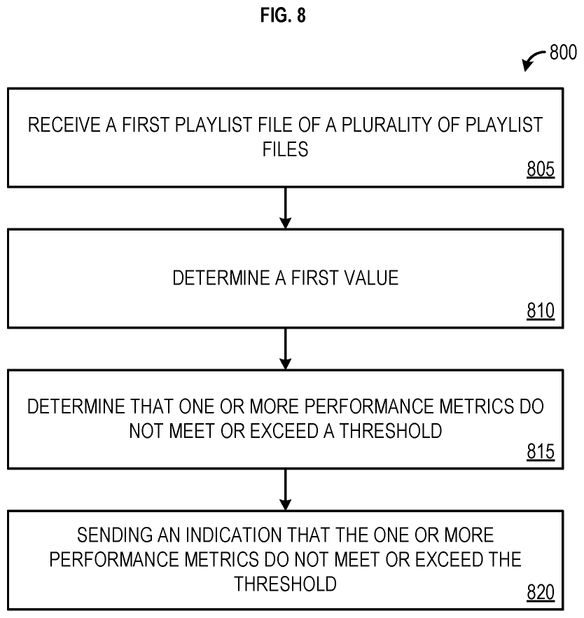

FIG. 8 shows a flowchart of an example method 800 for content stream monitoring. The method 800 may be performed in whole or in part by a single computing device (e.g., a client device), a plurality of computing devices, and the like. For example, the steps of the method 800 may be performed by the computing device 102C shown in FIG. 1. For purposes of explanation, the method 800 will be described as being performed by a single computing device. However, the method 800 may be performed by more than one computing device as well.

The computing device may receive an encoded stream of a content item. For example, the computing device may be a user device. The encoded stream may comprise, as an example, the content source stream 102. The encoded stream may comprise a plurality of encoded segments of the content item at a plurality of representations (e.g., bitrates).

At step 805, a first playlist file of a plurality of playlist files may be received. The first playlist file may be a variant playlist file of the plurality of variant playlist files 210, for example. As a further example, it may be determined whether a performance metric associated with the first playlist file meets or exceeds a threshold, as further described. As an example, a master playlist file (e.g., the master playlist file 205) may be received that may serve as an index to the plurality of playlist files. Each playlist file of the plurality of playlist files may be representative of the same content at varying resolutions/bitrates. The first resolution/bitrate may comprise a lowest-resolution/lowest-bitrate representation of the content, for example. However, the first resolution/bitrate may comprise a highest-resolution/lowest-bitrate representation of the content as well. While the master playlist file may be received (e.g., downloaded) once, the plurality of playlist files may be stored either locally, or stored remotely. The master playlist file may be downloaded more than once, for example. For example, the master playlist file may be downloaded more than once in the instance wherein a software update occurs.

At step 810, a first value associated with the first playlist file of the plurality of playlist files may be determined. For example, the first value may be determined based on the first playlist file. As another example, the first value may be determined based on the master playlist file. Each playlist file of the plurality of playlist files may comprise data. For example, each playlist file of the plurality of playlist files may comprise data, wherein the data may be indicative of a value (e.g., the first value). As the plurality of playlist files may be updated periodically, at any frequency, the data associated with each playlist file of the plurality of playlist files may change to reflect a successful update of the playlist file of the plurality of playlist files. For example, as the plurality of playlist files may be updated periodically, the data associated with each playlist file of the plurality of playlist files may change to reflect a second value. In the instance wherein a change may not be reflected in the start number, the content stream may be considered to be ‘dead’ (e.g., inaccessible, non-functional, etc.). As another example, in the instance wherein a change may not be reflected in the sequence number, the content stream may be considered to be ‘dead.’ As an additional example, in the instance wherein a number of content segments is not updated, the content stream may be considered to be ‘dead.’

At step 815, it may be determined that one or more performance metrics do not meet or exceed the threshold. The first value associated with the first playlist file of the plurality of playlist files, for example, may comprise one or more of a sequence number, a start number, an asset change, a cue message, or a number of content segments. The one or more performance metrics may be any metric associated with data associated with the content stream. For example, the one or more performance metrics may comprise the threshold. It may be determined that the first playlist file of the plurality of playlist files meets or exceeds the threshold based on a comparison between the sequence number/start number of a current playlist file (e.g., the current variant playlist 500B/600B) associated with the first playlist file of the plurality of playlist files and a sequence number/start number of a previous playlist file (e.g., the previous playlist file 500A/600A) associated with the first playlist file of the plurality of playlist files. Alternatively, it may be determined that the first playlist file of the plurality of playlist files meets or exceeds the threshold based on a number of content segments changing so that the consumption of one or more content segments may be indicated. As a further example, it may be determined that the playlist file has been updated based on a notification. The notification may be received. The notification may indicate any type of change to the value associated with the first playlist file of the plurality of playlist files. Additionally, or in the alternative, the first playlist file of the plurality of playlist files may be monitored so that real-time updates may be determined relative to a quality of the content stream. For example, the real-time updates may be determined relative to the quality of the content stream based on a cue message. The cue message may indicate an issue with the quality of the content stream. For example, the cue message may be a notification indicative of an error in the content stream, such as an alert that the sequence numbers or the start numbers are not being incremented. As a further example, it may be determined that the first playlist file has been updated based on a notification. The notification may be received. The notification may indicate a change(s) to the value associated with the first playlist files of the plurality of playlist files, such as a change in a sequence number, a start number, an asset change, a cue message indicating a change, or a change in the number of segments.

It may be determined that the first playlist file does not meet or exceed the threshold. In such a scenario, a request may be sent for an alternative playlist file of the plurality of playlist files (e.g., for output of the content item). It may also be determined whether each of the playlist files of the plurality of playlist files meet or exceed the threshold, concurrently. An instruction and/or a notification may cause a remedial action to be performed based on the threshold not being met or exceeded. For example, the instruction and/or notification may cause the content stream to be repaired, supplemented, and/or replaced, such as by indicating an error regarding the content stream. In monitoring the content stream, it may be determined that the network is non-functional (e.g., offline) in the instance wherein the change in the data may be non-existent, for example. As another example, an issue may be determined to be prevalent within the content stream if the change in data based on an update of the playlist file is less than a predetermined amount, or more than a predetermined amount. In either case, a remedial action may be made to cause the quality of the content stream to meet or exceed the threshold.

An instruction to monitor the one or more performance metrics may be received. For example the instructions may be based on a geographic location, a device platform, or a device capability. For example, the device capability may be associated with one or more of a rate plan, a connection speed, or a hardware performance.

At step 820, an indication that the one or more performance metrics do not meet or exceed the threshold may be sent. The data associated with each of the playlist files of the plurality of playlist files allow for the input of a content stream to be monitored. As an example, the input of the content stream may be monitored via a mobile application by integrating a content stream monitoring functionality within an existing software platform.

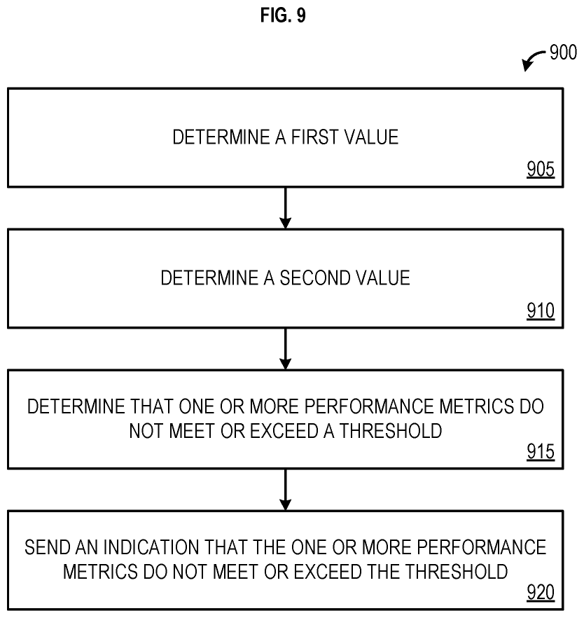

FIG. 9 shows a flowchart of an example method 900 for content stream monitoring. The method 900 may be performed in whole or in part by a single computing device (e.g., a client device), a plurality of computing devices, and the like. For example, the steps of the method 900 may be performed by the computing device 102C shown in FIG. 1. For purposes of explanation, the method 900 will be described as being performed by a single computing device. However, the method 900 may be performed by more than one computing device as well.

The computing device may receive an encoded stream of a content item. For example, the computing device may be a user device. The encoded stream may comprise, as an example, the content source stream 102. The encoded stream may comprise a plurality of encoded segments of the content item at a plurality of representations (e.g., bitrates).

At step 905, a first value associated with a first playlist file of a plurality of playlist files may be determined. For example, the first value may be determined based on the first playlist file. As another example, the first value may be determined based on a master playlist file (e.g., the master playlist file 205). The first playlist file may be received. The first playlist file may be a variant playlist file of the plurality of playlist files 210. For example, it may be determined whether a performance metric associated with the first playlist file meets or exceeds a threshold, as further described. As an example, the master playlist file that may serve as an index to the plurality of playlist files may be received, wherein each playlist file of the plurality of playlist files may be representative of the same content at varying resolutions/bitrates. The first resolution/bitrate may comprise a lowest-resolution/lowest-bitrate representation of the content, for example. As another example, the first resolution/bitrate may comprise a highest-resolution/lowest-bitrate representation of the content as well. While the master playlist file may be received (e.g., downloaded) once, the plurality of playlist files may be stored either locally, or stored remotely. As a further example, the master playlist file may be downloaded more than once. For example, the master playlist file may be downloaded more than once in the instance wherein a software update occurs.

At step 910, a second value may be determined. The second value may be determined based on the first playlist file. As the plurality of playlist files may be updated periodically, at any frequency, the second value may be an updated version of the first playlist file of the plurality of playlist files, for example.

At step 915, it may be determined that one or more performance metrics do not meet or exceed the threshold. For example, it may be determined that the one or more performance metrics do not meet or exceed the threshold based on a comparison between the first value and the second value. The first value and the second value, for example, may comprise one or more of a sequence number, a start number, an asset change, a cue message, or a number of content segments. The one or more performance metrics may be any metric associated with data associated with the content stream. For example, it may be determined that the first playlist file meets or exceeds the threshold based on a comparison between the sequence number/start number of a current playlist file (e.g., the current variant playlist file 500B/600B) associated with the first playlist file of the plurality of playlist files and a sequence number/start number of a previous playlist file (e.g., the previous playlist file 500A/600A) associated with the first playlist file of the plurality of playlist files. Alternatively, it may be determined that the first playlist file meets or exceeds the threshold based on a number of content segments changing so that the consumption of one or more content segments may be indicated. As a further example, it may be determined that the playlist file has been updated based on a notification that may be received that may be indicative of any type of change to the value associated with the first playlist file of the plurality of playlist files. Additionally, for example, the first playlist file of the plurality of playlist files may be monitored so that real-time updates may be determined relative to a quality of the content stream via a cue message that may indicate an issue with the quality of the content stream. For example, the cue message may be a notification indicative of an error in the content stream, such as an alert that the sequence numbers or the start numbers are not being incremented. It may be determined, for example, that the first playlist file does not meet or exceed the threshold, and a request for an alternative playlist file of the plurality of playlist files to stream the content may be made. It may also be determined whether each of the playlist files of the plurality of playlist files meets or exceeds the threshold, concurrently. A remedial action to repair, supplement, or replace the particular content segment that is being streamed may be caused by indicating an error (e.g., an instruction and/or a notification). In monitoring the content stream, it may be determined that the network is non-functional (e.g., offline) in the instance wherein the change in the data may be non-existent, for example. A further indication that an issue may be prevalent within the content stream is if the change in data based on an update of the playlist file is less than a predetermined amount, or more than a predetermined amount. In either case, a remedial action may be made to cause the quality of the content stream to meet or exceed the threshold.

An instruction to monitor the one or more performance metrics may be received. For example, the instructions may be based on a geographic location, a device platform, or a device capability. As a further example, the device capability may be associated with one or more of a rate plan, a connection speed, or a hardware performance.

At step 920, an indication that the one or more performance metrics do not meet or exceed the threshold may be sent. Additional values associated with additional playlist files of the plurality of playlist files may be continued to be determined. For example, a third value associated with a second playlist file of the plurality of playlist files may be determined. As the plurality of playlist files may be updated periodically, at any frequency, the second playlist file of the plurality of playlist files may be a rendition of the first playlist file of the plurality of playlist files at a different bit rate, for example. A third value of the second playlist file may be compared with a fourth value of the second playlist file to determine whether the one or more performance metrics do not meet or exceed the threshold as is described in step 915, for example.

The data associated with each of the playlist files of the plurality of playlist files may allow for the received input of a content stream to be monitored. As an example, the input of the content stream may be monitored via a mobile application by integrating a content stream monitoring functionality within an existing software platform.

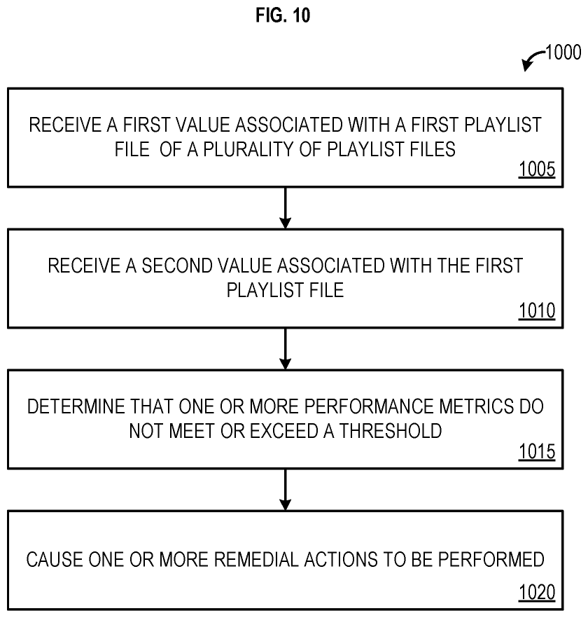

FIG. 10 shows a flowchart of an example method 1000 for content stream monitoring. The method 1000 may be performed in whole or in part by a single computing device, a plurality of computing devices, and the like. For example, the steps of the method 1000 may be performed by the computing device 102A, 102B shown in FIG. 1. For purposes of explanation, the method 1000 will be described as being performed by a single computing device. However, the method 1000 may be performed by more than one computing device as well.

The computing device may receive an encoded stream of a content item. The encoded stream may comprise, as an example, the content source stream 114. The encoded stream may comprise a plurality of encoded segments of the content item at a plurality of representations (e.g., bitrates). The computing device may send a user device an instruction to monitor one or more performance metrics. For example the instructions may be based on a geographic location of the user device, a device platform, or a device capability. For example, the device capability may be associated with one or more of a rate plan, a connection speed, or a hardware performance.

At step 1005, a first value associated with a first playlist file of a plurality of playlist files may be received. The data associated with the first playlist file of the plurality of playlist files may be collected. The data associated with the first playlist file of the plurality of playlist files may also be sent.

At step 1010, a second value associated with the first playlist file of the plurality of playlist files may be received. As the plurality of playlist files may be updated periodically, at any frequency, the second value associated with the first playlist file of the plurality of playlist files may be indicative of an updated version of the first playlist file of the plurality of playlist files, for example.

At step 1015, it may be determined that the one or more performance metrics do not meet or exceed the threshold. For example, it may be determined that the one or more performance metrics do not meet or exceed the threshold based on a comparison between the first value and the second value. The first value and the second value, for example, may comprise one or more of a sequence number, a start number, an asset change, a cue message, or a number of content segments. The one or more performance metrics may be any metric associated with data associated with the content stream. For example, it may be determined that the first playlist file of the plurality of playlist files meets or exceeds the threshold based on a comparison between the sequence number/start number of a current playlist file (e.g., the current variant playlist file 500B/600B) associated with the first playlist file of the plurality of playlist files and a sequence number/start number of a previous playlist file (e.g., the previous playlist file 500A/600A) associated with the first playlist file of the plurality of playlist files. Alternatively, it may be determined that the first playlist file of the plurality of playlist files meets or exceeds the threshold based on a number of content segments changing so that the consumption of one or more content segments may be indicated. As a further example, it may be determined that the playlist has been updated based on a notification that may be received that may be indicative of any type of change to the value associated with the first playlist file of the plurality of playlist files. Additionally, for example, the first playlist file of the plurality of playlist files may be monitored so that real-time updates may be determined relative to a quality of the content stream via a cue message that may indicate an issue with the quality of the content stream. For example, the cue message may be a notification indicative of an error in the content stream, such as an alert that the sequence numbers or the start numbers are not being incremented.

It may be determined that the first playlist file does not meet or exceed the threshold and a request for an alternative playlist file of the plurality of playlist files to stream the content may be made. It may also be determined whether each of the playlist files of the plurality of playlist files meet or exceed the threshold, concurrently. An instruction and/or notification may cause a remedial action to repair, supplement, or replace the particular content segment that may be streamed by indicating an error. In monitoring the content stream, it may be determined that the network is non-functional (e.g., offline) in the instance wherein the change in the data may be non-existent, for example. As another example, it may be determined that an issue may be prevalent within the content stream if the change in data based on an update of the playlist file may be less than a predetermined amount, or more than a predetermined amount. In either case, a remedial action may be made to cause the quality of the content stream to meet or exceed the threshold.

At step 1020, one or more remedial actions may be caused to be performed. For example, an indication (e.g., an instruction and/or notification) may be sent that may cause a third value associated with a second playlist file of the plurality of playlist files to be sent, based on a determination that the one or more performance metrics do not meet or exceed the threshold. The first playlist file may also be updated. As another example, instructions may be sent to stream an alternative playlist file of the plurality of playlist files. In an additional example, instructions may be sent to cause the streaming of the playlist file to pause, until the bandwidth of the network has improved enough to support the updates to the playlist file so that the updates to the playlist file will meet or exceed the threshold.

Additional values associated with additional playlist files of the plurality of playlist files may be continued to be received. For example, the third value associated with the second playlist file of the plurality of playlist files may be received. As the plurality of playlist files may be updated periodically, at any frequency, the second playlist file of the plurality of playlist files may be a rendition of the first playlist file of the plurality of playlist files at a different bit rate, for example. The third value of the second playlist file may be compared with a fourth value of the second playlist file to determine that one or more performance metrics do not meet or exceed the threshold as is described in step 1015, for example.

The data associated with each of the playlist files of the plurality of playlist files allow for the input of the content stream to be monitored. As an example, the input of the content stream may be monitored via a mobile application by integrating the content stream monitoring functionality within an existing software platform.

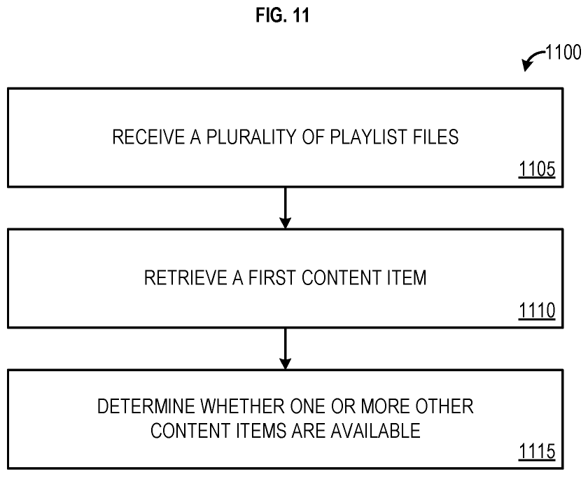

FIG. 11 shows a flowchart of an example method 1100 for content stream monitoring. The method 1100 may be performed in whole or in part by a single computing device (e.g., a client device), a plurality of computing devices, and the like. For example, the steps of the method 1100 may be performed by the computing device 102C shown in FIG. 1. For purposes of explanation, the method 1100 will be described as being performed by a single computing device. However, the method 1100 may be performed by more than one computing device as well.

At step 1105, a user device may receive a plurality of playlist files. Each playlist file, of the plurality of playlist files, may correspond to a different content item. The user device may receive an instruction to monitor a content stream associated with the first playlist file. The instruction may be based on one or more of: a geographic location, a device platform, or a device capability. The device capability may be associated with one or more of: a rate plan, a connection speed, or hardware performance.

At step 1110, the user device may retrieve a first content item. For example, the user device may retrieve the first content item based on a first playlist file of the plurality of playlist files. The first content item may correspond to the first playlist file. At step 1115, the user device may determine whether one or more other content items are available. For example, the user device may determine whether one or more content streams associated with the one or more other content items are available/accessible. The one or more other content items may correspond to the one or more other playlist files. The first playlist file may differ from the one or more other playlist files.

Additionally, or in the alternative, the user device may determine whether the one or more other content items are available based on one or more performance metrics. The one or more performance metrics may be associated with the one or more other content items. The user device may determine whether the one or more other content items are available based on the one or more performance metrics meeting or exceeding a threshold. The threshold may be associated with the one or more content streams associated with the one or more other content items. The threshold being met or exceeded may be indicative of the one or more other content items not being available.

The user device may determine whether the one or more performance metrics meet or exceed the threshold in a variety of ways. For example, the user device may determine whether the one or more performance metrics meet or exceed the threshold based on one or more sequence numbers. The one or more sequence numbers may be associated with the one or more other playlist files, and the threshold may be associated with the one or more sequence numbers.

Additionally, or in the alternative, the user device may determine whether the one or more performance metrics meet or exceed the threshold based on one or more start numbers. The one or more start numbers may be associated with the one or more other playlist files, and the threshold may be associated with the one or more start numbers. Additionally, or in the alternative, the user device may determine whether the one or more performance metrics meet or exceed the threshold based on a quantity of content segments. The quantity of content segments may be associated with the one or more other playlist files, and the threshold may be associated with the quantity of content segments.

The user device may send an indication that the one or more performance metrics are indicative of the one or more other content items not being available. For example, the user device may send the indication when the one or more performance metrics meet or exceed the threshold. The user device may send the indication to an upstream device(s), a content server(s), and/or the like.

The user device may cause one or more remedial actions to be performed as described herein. For example, the user device may cause the one or more remedial actions to be performed based on the one or more other content items not being available. The threshold being met or exceeded may be indicative of the one or more other content items not being available. The user device may cause the one or more remedial actions to be performed when the threshold is met or exceeded (e.g., when the one or more other content items are not available). Other examples are possible as well.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
receiving, by a user device, a plurality of playlist files, wherein each playlist file, of the plurality of playlist files, corresponds to a different content item;
retrieving, based on a first playlist file of the plurality of playlist files, a first content item corresponding to the first playlist file; and
determining, based on one or more other playlist files of the plurality of playlist files, whether one or more other content items corresponding to the one or more other playlist files are available.

2. The method of claim 1, wherein retrieving the first content item corresponding to the first playlist file comprises receiving an instruction to monitor a content stream associated with the first playlist file.

3. The method of claim 2, wherein the instruction is based on one or more of: a geographic location, a device platform, or a device capability associated with one or more of: a rate plan, a connection speed, or hardware performance.

4. The method of claim 1, wherein the first playlist file differs from the one or more other playlist files.

5. The method of claim 1, wherein determining whether the one or more other content items corresponding to the one or more other playlist files are available comprises determining whether one or more performance metrics associated with the one or more other content items meet or exceed a threshold.

6. The method of claim 5, wherein determining whether the one or more performance metrics meet or exceed the threshold comprises one or more of:
determining, based on one or more sequence numbers associated with the one or more other playlist files, whether the one or more performance metrics meet or exceed the threshold, wherein the threshold is associated with the one or more sequence numbers;
determining, based on one or more start numbers associated with the one or more other playlist files, whether the one or more performance metrics meet or exceed the threshold, wherein the threshold is associated with the one or more start numbers; or
determining, based on a quantity of content segments associated with the one or more other playlist files, whether the one or more performance metrics meet or exceed the threshold, wherein the threshold is associated with the quantity of content segments.

7. The method of claim 1, further comprising one or more of:
causing, based on the one or more other content items not being available, one or more remedial actions to be performed; or
sending, to a computing device, an indication that one or more performance metrics, associated with the one or more other content items, are indicative of the one or more other content items not being available.

8.-20. (canceled)

21. An apparatus comprising:
one or more processors; and
memory storing processor-executable instruction that, when executed by the one or more processors, cause the apparatus to:
receive a plurality of playlist files, wherein each playlist file, of the plurality of playlist files, corresponds to a different content item;
retrieve, based on a first playlist file of the plurality of playlist files, a first content item corresponding to the first playlist file; and
determine, based on one or more other playlist files of the plurality of playlist files, whether one or more other content items corresponding to the one or more other playlist files are available.

22. The apparatus of claim 21, wherein the processor-executable instructions, that, when executed by the one or more processors, cause the apparatus to retrieve the first content item corresponding to the first playlist file, further cause the apparatus to receive an instruction to monitor a content stream associated with the first playlist file.

23. The apparatus of claim 22, wherein the instruction is based on one or more of: a geographic location, a device platform, or a device capability associated with one or more of: a rate plan, a connection speed, or hardware performance.

24. The apparatus of claim 21, wherein the first playlist file differs from the one or more other playlist files.

25. The apparatus of claim 21, wherein the processor-executable instructions that, when executed by the one or more processors, cause the one or more processors to determine whether the one or more other content items corresponding to the one or more other playlist files are available, further cause the one or more processors to determine whether one or more performance metrics associated with the one or more other content items meet or exceed a threshold.

26. The apparatus of claim 25, wherein the processor-executable instructions that, when executed by the one or more processors, cause the one or more processors to determine whether the one or more performance metrics meet or exceed the threshold further cause the one or more processors to one or more of:
determine, based on one or more sequence numbers associated with the one or more other playlist files, whether the one or more performance metrics meet or exceed the threshold, wherein the threshold is associated with the one or more sequence numbers;
determine, based on one or more start numbers associated with the one or more other playlist files, whether the one or more performance metrics meet or exceed the threshold, wherein the threshold is associated with the one or more start numbers; or
determine, based on a quantity of content segments associated with the one or more other playlist files, whether the one or more performance metrics meet or exceed the threshold, wherein the threshold is associated with the quantity of content segments.

27. The apparatus of claim 21, wherein the processor-executable instructions, when executed by the one or more processors, further cause the apparatus to:
cause, based on the one or more other content items not being available, one or more remedial actions to be performed; or
send, to a computing device, an indication that one or more performance metrics, associated with the one or more other content items, are indicative of the one or more other content items not being available.

28. One or more non-transitory computer-readable media storing processor-executable instructions thereon, which, when executed by at least one processor cause the at least one processor to:
receive a plurality of playlist files, wherein each playlist file, of the plurality of playlist files, corresponds to a different content item;
retrieve, based on a first playlist file of the plurality of playlist files, a first content item corresponding to the first playlist file; and
determine, based on one or more other playlist files of the plurality of playlist files, whether one or more other content items corresponding to the one or more other playlist files are available.

29. The one or more non-transitory computer-readable media of claim 28, wherein the processor-executable instructions, that, when executed by the at least one processor, cause the at least one processor to retrieve the first content item corresponding to the first playlist file, further cause the at least one processor to receive an instruction to monitor a content stream associated with the first playlist file.

30. The one or more non-transitory computer-readable media of claim 29, wherein the instruction is based on one or more of:
a geographic location, a device platform, or a device capability associated with one or more of: a rate plan, a connection speed, or hardware performance.

31. The one or more non-transitory computer-readable media of claim 28, wherein the first playlist file differs from the one or more other playlist files.

32. The one or more non-transitory computer-readable media of claim 28, wherein the processor-executable instructions that, when executed by the at least one processor, cause the at least one processor to determine whether the one or more other content items corresponding to the one or more other playlist files are available, further cause the at least one processor to determine whether one or more performance metrics associated with the one or more other content items meet or exceed a threshold.

33. The one or more non-transitory computer-readable media of claim 32, wherein the processor-executable instructions that, when executed by the at least one processor, cause the at least one processor to determine whether the one or more performance metrics meet or exceed the threshold further cause the at least one processor to one or more of:
determine, based on one or more sequence numbers associated with the one or more other playlist files, whether the one or more performance metrics meet or exceed the threshold, wherein the threshold is associated with the one or more sequence numbers;
determine, based on one or more start numbers associated with the one or more other playlist files, whether the one or more performance metrics meet or exceed the threshold, wherein the threshold is associated with the one or more start numbers; or
determine, based on a quantity of content segments associated with the one or more other playlist files, whether the one or more performance metrics meet or exceed the threshold, wherein the threshold is associated with the quantity of content segments.

34. The one or more non-transitory computer-readable media of claim 28, wherein the processor-executable instructions, when executed by the at least one processor, further cause the at least one processor to:
cause, based on the one or more other content items not being available, one or more remedial actions to be performed; or
send, to a computing device, an indication that one or more performance metrics, associated with the one or more other content items, are indicative of the one or more other content items not being available.
